(19) United States
(12) Patent Application Publication
(10) Pub. No.: US 2003/0081319 A1
(43) Pub. Date: May 1, 2003

(54) Tunable optical filter

(75) Inventor: Shaoly Hsu, Hsin-Chu (TW)

Correspondence Address: WEI TE CHUNG, FOXCONN INTERNATIONAL, INC., 1650 MEMOREX DRIVE, SANTA CLARA, CA, 95050, US

(73) Assignee: Wei Te Chung Foxconn International, Inc, Santa Clara, CA (US)

(21) Appl. No.: 10/033,650

(22) Filed: Dec. 27, 2001

(30) Foreign Application Priority Data
Oct. 31, 2001 (TW) 90126989

(51) Int. Cl. G02B 27/00

(52) U.S. Cl. 359/579; 359/577

(57) ABSTRACT

A tunable filter (4) includes a thin film filter (2) and an electric controller (3). The thin film filter includes a transparent substrate (28) and a thin film filter stack (20). The thin film filter stack is constructed as a Fabry-Perot etalon, including a central spacer (26) and two multi-reflective layers (22, 24) respectively on opposite sides of the spacer. One multi-reflective layer is an H(LH)^{P-1} film system, the other multi-reflective layer is an (HL)^{P-1}H film system. The spacer includes a transparent dielectric film having an optical thickness equal to one half of a predetermined transmitting central wavelength. The transparent dielectric film is made of piezoelectric material whose optical thickness is controllably variable. The controller receives and analyzes optical signals, and automatically controls the thin film filter stack to allow passage of the transmitting central wavelength. The control is achieved by adjusting an optical thickness of the central spacer.

### BACKGROUND OF THE INVENTION

1. Field of the Invention

The present invention relates to optical filters, and more particularly to a tunable filter which has a piezoelectric layer and two multi-reflective layers beside the piezoelectric layer whereby characteristics of the filter can be accurately controlled to precisely transmit light signals having a desired wavelength.

2. Description of the Prior Art

In recent years, optical fiber technology for telecommunications has progressed rapidly. The theoretically very high transmission capacity of single-mode optical fibers has been recognized in the industry for a long time. However, to date, much of that capacity has not been utilized. Increasing demands for bandwidth are being fuelled by needs such as the transmission of video images and graphics. Therefore, much attention has been directed lately toward maximum utilization of bandwidth of single-mode fibers. Common means for increasing bandwidth utilization include dense wavelength division multiplexing (DWDM) and time division multiplexing.

In a DWDM system, optical signals having different wavelengths that are emitted by multiple signal sources are coupled into one single-mode fiber by means of a multiplexer. After the signals having different wavelengths are transmitted through the fiber to a desired destination, the multiplexed signals are separated into separate optical channels by means of a demultiplexer. Typically, a thin film filter is used in the demultiplexer to select out a signal having a specific wavelength. The selected signal is then output into a corresponding channel. To divide multiplexed signals having wavelengths that differ by only several nanometers, it is necessary to use a number of filters. Each filter only allows a light signal having a precise desired wavelength to pass therethrough.

As shown in FIG. 1, a conventional thin film filter 1 comprises a plurality of dielectric coatings (not labeled) superposed on a substrate 12. The substrate 12 may be composed of quartz glass. All but one of the dielectric coatings comprise two different films respectively having high (n_{H}) and low (n_{L}) refractive indexes. The two different films are alternately stacked one on another. Each film has an optical thickness equal to a quarter of a transmitting central wavelength λ₀. One dielectric coating in a middle of the plurality of dielectric coatings is defined as a spacer 10, and comprises two films which are both low refractive index layers. Thus a total optical thickness of the spacer 10 is equal to one half of the transmitting central wavelength λ₀. With these characteristics, the plurality of dielectric coatings is structured as a Fabry-Perot etalon. Typically, it can be expressed as GH(LH)^{P-1}LL(HL)^{P-1}HA, in which G is the substrate 12, P is the number of dielectric coatings and A is an air layer. H(LH)^{P-1} and (HL)^{P-1}H respectively form two mirrors of the Fabry-Perot etalon, and LL is the spacer of the Fabry-Perot etalon.

To attain maximum transmittance, the thin film filter 1 should satisfy the following relationship:

2nd.cos θ=mλ [Eq. 1]

wherein θ is an internal angle of incidence of input optical signals, n is the refractive index of the spacer 10, d is the physical thickness of the spacer 10 and λ is a transmitting central wavelength. Equation 1 shows that the transmitting central wavelength varies according to the internal angle of incidence θ and the optical thickness nd of the spacer 10. If the angle of incidence θ changes, the transmitting central wavelength λ changes accordingly. In such case, the thin film filter 1 cannot precisely transmit light signals having the desired wavelength.

In addition, the physical thickness d of the spacer 10 is very sensitive to changes in temperature. Thus under normal operating conditions, the thin film filter 1 cannot precisely transmit light signals having the desired wavelength.

It is therefore desired to provide an improved optical thin film filter which can be accurately controlled to precisely transmit light signals having a desired wavelength.

### SUMMARY OF THE INVENTION

Accordingly, an object of the present invention is to provide a tunable filter which precisely transmits a light signal having a desired wavelength in an accurately controllable manner.

Another object of the present invention is to provide a tunable filter having a piezoelectric layer for adjusting a desired wavelength of transmitted optical signals.

A further object of the present invention is to provide a tunable filter which allows relatively high tolerance during manufacturing thereof.

To achieve the objects set forth, the present invention provides a tunable filter comprising a thin film filter and an electric controller. The thin film filter comprises a transparent substrate and a thin film filter stack. The thin film filter stack is constructed as a Fabry-Perot etalon, comprising a central spacer and two multi-reflective layers respectively on opposite sides of the spacer. One multi-reflective layer is an H(LH)^{P-1} film system, and the other multi-reflective layer is an (HL)^{P-1}H film system. The spacer comprises a transparent dielectric film having an optical thickness equal to one half of a predetermined transmitting central wavelength λ₀. The transparent dielectric film is made of piezoelectric material whose optical thickness is controllably variable. The spacer further defines a hole in a center of the film. The controller receives and analyzes optical signals, and automatically controls the thin film filter stack to allow passage of the transmitting central wavelength λ₀. The control is achieved by adjusting an optical thickness of the central spacer.

Other objects, advantages and novel features of the invention will become more apparent from the following detailed description when taken in conjunction with the accompanying drawings.

### BRIEF DESCRIPTION OF THE DRAWINGS

FIG. 1 is a sectional view of a conventional thin film filter;

FIG. 2 is a schematic sectional view of a thin film filter in accordance with a preferred embodiment of the present invention;

FIG. 3 is a circuit diagram of an electric controller for controlling the thin film filter of FIG. 2;

FIG. 4 is a schematic view of the thin film filter of FIG. 2 connected to the electric controller of FIG. 3; and

FIG. 5 is a schematic view of a thin film filter in accordance with an alternative embodiment of the present invention connected to the electric controller of FIG. 3.

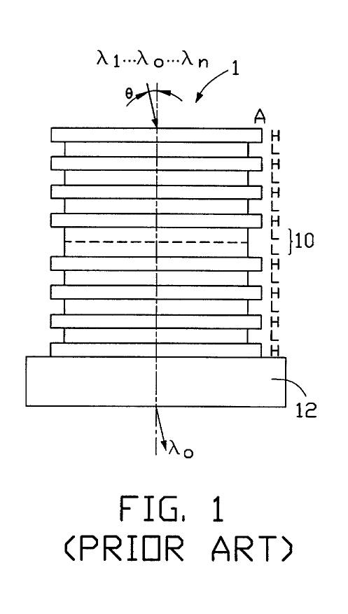

### DETAILED DESCRIPTION OF THE INVENTION

For facilitating understanding, like components are designated by like reference numerals throughout the various embodiments of the invention as shown in the various drawing figures.

Reference will now be made to the drawing figures to describe the present invention in detail.

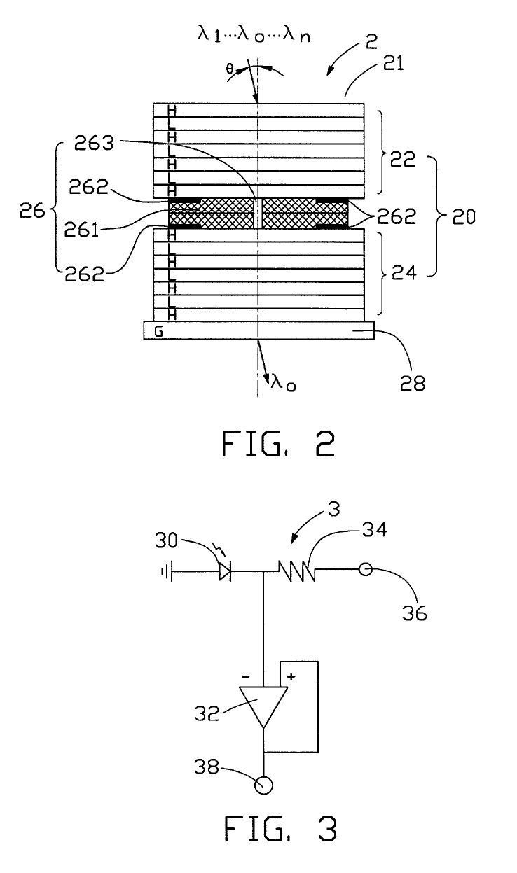

Referring to FIG. 2, a thin film filter 2 in accordance with a preferred embodiment of the present invention comprises a transparent substrate 28 and a thin film filter stack 20 superposed on the substrate 28. In the preferred embodiment, the substrate 28 is made of quartz glass. The thin film filter stack 20 comprises a central spacer 26, and two multi-reflective layers 22, 24 respectively on opposite sides of the central spacer 26. Each multi-reflective layer 22, 24 comprises a plurality of dielectric coatings (not labeled). Each dielectric coating comprises two different films respectively having high (n_{H}) and low (n_{L}) reflective indexes. The two different films are alternately stacked one on another. In the preferred embodiment, each multi-reflective layer 22, 24 comprises scores of the two different films. Each film has an optical thickness equal to a quarter of a predetermined transmitting central wavelength λ₀. The films adjacent the substrate 28, the central spacer 26 and an outer air layer 21 all have high refractive index (n_{H}). The central spacer 26 comprises a transparent dielectric film 261 having a low refractive index (n_{L}′). A hole 263 is defined through a center of the transparent dielectric film 261. The transparent dielectric film 261 is made of a transparent material whose optical thickness is controllably variable, such as piezoelectric, electro-optic or magneto-optic material. In the preferred embodiment, the transparent dielectric film 261 is made of piezoelectric material and has an optical thickness equal to one half of the transmitting central wavelength λ₀. The transparent dielectric film 261 has a physical width less than a physical width of the multi-reflective layers 22, 24. Accordingly, the thin film filter 2 has a periphery which is recessed at the transparent dielectric film 261. The central spacer 26 further comprises two electrodes 262 embedded in the transparent dielectric film 261. Each electrode 262 is exposed to the recessed periphery of the thin film filter 2. The electrodes 262 are electrically connected to an electric controller 3 (see FIG. 3). The electric controller 3 accurately controls electrical potential applied to the transparent dielectric film 261, to accurately control the refractive index n_{L}′ and the physical thickness d′ of the transparent dielectric film 261 according to required parameters. Thus, the thin film filter 2 can precisely transmit light signals even when a transmitting temperature and an angle of incidence of input optical signals change.

To attain maximum transmittance, the thin film filter 2 should satisfy the following relationship:

2n_{L}′d′.cos θ=mλ₀ [Eq. 2]

wherein θ is the internal angle of incidence of input light signals, n_{L}′ and d′ are respectively the refractive index and the physical thickness of the transparent dielectric film 261, and λ₀ is the transmitting central wavelength of the thin film filter 2.

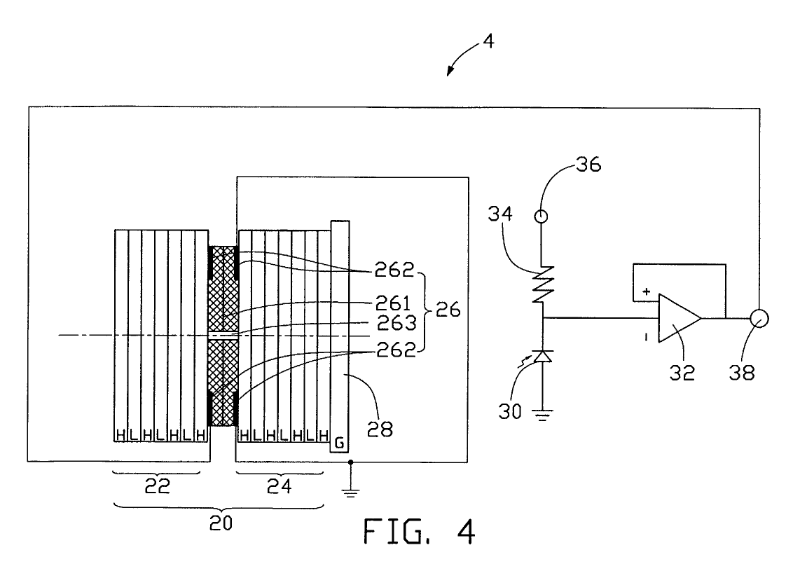

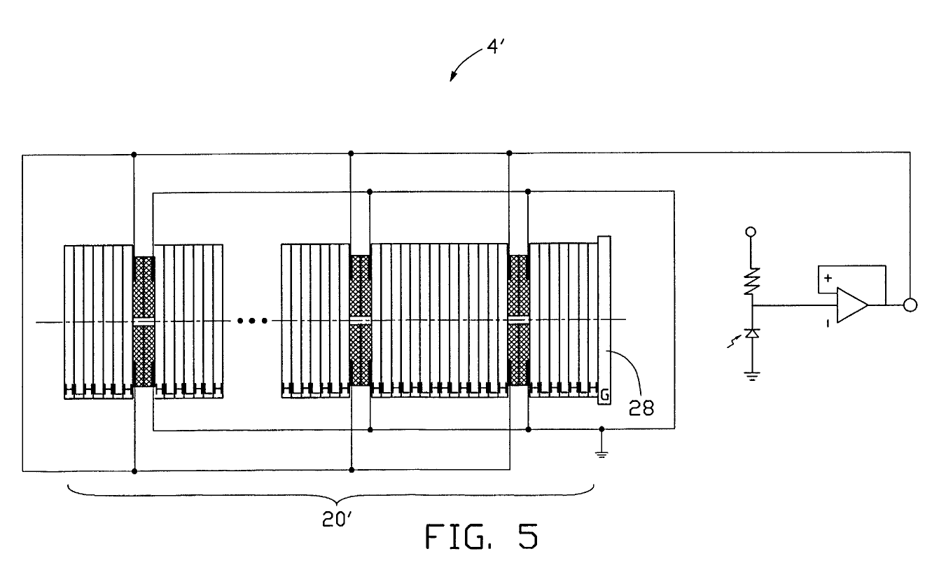

Referring to FIGS. 3 and 4, a tunable filter 4 in accordance with the present invention comprises an electric controller 3 to control the optical thickness n_{L}′d′ of the transparent dielectric film 261. This ensures reliable transmission of the transmitting central wavelength λ₀, even when the angle of incidence θ of the input optical signals changes.

The electric controller 3 comprises a photodiode 30, an operational amplifier 32, and a resistor 34 for protecting the photodiode 30. An offset voltage 36 is applied on the resistor 34 and the photodiode 30. The operational amplifier 32 has an output voltage 38. An output current of the photodiode 30 is equal to I₀ when the predetermined transmitting central wavelength of the thin film filter 2 is λ₀. The operational amplifier 32 includes a comparison current which is equal to the output current I₀. In assembly, the output voltage 38 is connected with one electrode 262 that is adjacent the multi-reflection layer 22. Another electrode 262 that is adjacent the multi-reflection layer 24 is connected with ground. Thus the tunable filter 4 including the thin film filter 2 and the electric controller 3 is formed.

In use, when the actual transmitting wavelength of the thin film filter 2 is equal to λ₀, then the output voltage 38 of the operational amplifier 32 is equal to zero. When the actual transmitting wavelength is greater or less than λ₀, the output current of the photodiode 30 is correspondingly greater or less than the predetermined output current I₀. Accordingly, the output voltage 38 applies a positive or negative voltage to the electrode 262 that is adjacent the multi-reflection layer 22. The positive or negative voltage corresponds to the change of the output current of the photodiode 30. The output voltage 38 controls the physical thickness d′ and the refractive index n′ of the transparent dielectric film 261. Accordingly, the output voltage 38 adjusts the optical thickness of the central spacer 26 to enable the thin film filter 2 to transmit the required transmitting central wavelength λ₀.

In the present invention, the optical thickness of the transparent dielectric film 261 is accurately controllable. Thus, the transparent dielectric film 261 can be manufactured with relatively high tolerance. The tunable filter 4 is still fully functional by means of the electric controller 3. Thus, manufacturing efficiency is increased.

In addition, by adjusting the comparison current of the operational amplifier 32, the tunable filter 4 can be tuned to obtain transmitting central wavelengths other than λ₀.

In other embodiments of the present invention, the electric controller 3 of the tunable filter 4 may comprise other structures that perform the same function as described for the preferred embodiment. For example, the electric controller 3 may detect optical signals in the tunable filter 4, convert the optical signals to electrical signals for analysis, after then automatically control the thin film filter stack to allow passage of the transmitting central wavelength λ₀.

Referring to FIG. 5, a tunable filter 4′ in accordance with an alternative embodiment of the present invention is similar to the tunable filter 4 of the preferred embodiment. The tunable filter 4′ comprises a thin film filter stack 20′, the glass substrate 28 and the electric controller 3. The thin film filter stack 20′ comprises at least two of the thin film filter stacks 20 of the preferred embodiment stacked on the substrate 28. Adjacent thin film filter stacks 20 are in direct contact with each other. In the alternative embodiment, the thin film filter stack 20′ prefer ably comprises three or four thin film filter stacks 20. This yields optimal filtering of the tunable filter 4′. A waveform of filtered light from the tunable filter 4′ approaches that of an ideal square wave.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tunable thin film filter comprising:
a transparent substrate;
two multi-reflective layers located on the substrate, each of the multi-reflective layers including a plurality of dielectric films respectively having high and low refractive indexes alternately stacked one on another;
a central spacer located between the two multi-reflective layers and including a transparent dielectric film having a low refractive index and an adjustable optical thickness substantially equal to one half of a predetermined transmitting central wavelength of the thin film filter;

2. The tunable thin film filter as described in claim 1, wherein the central spacer further comprises electrodes at opposite sides of the transparent dielectric film, whereby the optical thickness of the transparent dielectric film is adjustable by altering a voltage applied on the electrodes.

3. The tunable thin film filter as described in claim 1, wherein the transparent dielectric film is made of piezoelectric material.

4. The tunable thin film filter as described in claim 1, wherein a hole is defined in a middle of the transparent dielectric film.

5. The tunable thin film filter as described in claim 1, wherein each of the dielectric films of the two multi-reflective layers has an optical thickness equal to a quarter of the predetermined transmitting central wavelength.

6. The tunable thin film filter as described in claim 1, wherein the transparent dielectric film is made of electro-optic material.

7. The tunable thin film filter as described in claim 1, wherein the transparent dielectric film is made of magneto-optic material.

8. The tunable thin film filter as described in claim 1, wherein more than two of the multi-reflective layers are located on the substrate.

9. The tunable thin film filter as described in claim 1, wherein four of the dielectric films are respectively contiguous with the substrate, the central spacer and an outer air layer, and each of said four of the dielectric films has a high refractive index.

10. A tunable filter adapted to transmit optical signals having a predetermined wavelength, the tunable filter comprising:
a transparent substrate;
two multi-reflective layers located on the substrate, each of the multi-reflective layers including a plurality of dielectric films respectively having high and low refractive indexes alternately stacked one on another;
a central spacer located between the two multi-reflective layers, the central spacer including a transparent dielectric film which is made of piezoelectric material, a first electrode mounted at a first side of the transparent dielectric film, and a second electrode mounted at a second side of the transparent dielectric film; and
an electric controller comprising light detecting means for receiving output light signals and converting the output light signals into electrical current, an operational amplifier for comparing the electrical current with a predetermined current value corresponding to the predetermined wavelength and for outputting a voltage to the first electrode if the electrical current is not equal to the predetermined current value, wherein the second electrode is connected to ground.

11. The tunable filter as described in claim 10, wherein the transparent dielectric film has an optical thickness substantially equal to one half of the predetermined transmitting central wavelength.

12. The tunable filter as described in claim 10, wherein the light detecting means of the electric controller comprises a photodiode, and the electric controller comprises a resistor.

13. The tunable filter as described in claim 10, wherein more than two of the multi-reflective layers are located on the substrate.

14. A tunable filter comprising:
a transparent substrate;
two multi-reflective layers located on the substrate, each of the multi-reflective layers including a plurality of dielectric films respectively having high and low refractive indexes alternately stacked one on another;
a central spacer located between the two multi-reflective layers and including a transparent dielectric film having an adjustable optical thickness; and
electric controller means electrically connecting with the transparent dielectric film for adjusting an optical thickness of the transparent dielectric film in response to an output light signal, wherein when the output light signal has a wavelength equal to a predetermined transmitting central wavelength of the tunable filter, no adjustment of the optical thickness of the transparent dielectric film is made by the electric controller means.

15. The tunable filter as described in claim 14, wherein the transparent dielectric film is made of piezoelectric material and has an optical thickness substantially equal to one half of the predetermined transmitting central wavelength.

16. The tunable filter as described in claim 14, wherein the central spacer further includes electrodes at opposite sides of the transparent dielectric film, and the electric controller means connects with the transparent dielectric film through the electrodes.

17. The tunable filter as described in claim 14, wherein the electric controller means comprises a photodiode, a resistor and an operational amplifier.

18. The tunable filter as described in claim 14, wherein more than two of the multi-reflective layers are located on the substrate.

19. A method of making a tunable thin film filter comprising steps of:
providing a transparent substrate;
providing two multi-reflective layers on the substrate, each of said multi-reflective layers including a plurality of dielectric films respectively having high and lo refractive indexes alternately staked one on another; and
providing a central spacer, located between said two multi-reflective layers, with a transparent dielectric film and means for controlling an optical thickness of the transparent dielectric film.
